(19) United States
(12) Patent Application Publication
(10) Pub. No.: US 2010/0235617 A1
(43) Pub. Date: Sep. 16, 2010

(54) SYSTEM RECOVERY METHOD AND EMBEDDED SYSTEM WITH AUTOMATIC RECOVERY FUNCTION

(75) Inventor: Jr-Bin Chen, Taipei County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: VIVOTEK INC., Taipei County (TW)

(21) Appl. No.: 12/719,429

(22) Filed: Mar. 8, 2010

(30) Foreign Application Priority Data
Mar. 10, 2009 (TW) 098107717

(51) Int. Cl. G06F 15/177; G06F 9/445

(52) U.S. Cl. 713/2

(57) ABSTRACT

A system recovery method and an embedded system with an automatic recovery function used between a network and a server are introduced. The embedded system includes a nonvolatile memory storing a first part program code and a processor electrically connected to the nonvolatile memory and the network. The method includes the following steps, the embedded system enters a boot process; when the processor of the embedded system in the boot process determines that the first part program code in the nonvolatile memory does not satisfy a first specific condition, the processor transmits a signal through the network to establish a signal connection with the server; and the processor downloads a backup program code from the server through the network for execution to complete the boot process.

### CROSS-REFERENCE TO RELATED APPLICATIONS

This non-provisional application claims priority under 35 U.S.C. §119(a) on Patent Application No(s). 098107717 filed in Taiwan, R.O.C. on Mar. 10, 2009, the entire contents of which are hereby incorporated by reference.

### BACKGROUND OF THE INVENTION

1. Field of Invention

The present invention relates to a system recovery method and an embedded system with an automatic recovery function, and more particularly to a system recovery method and an embedded system with an automatic recovery function used between a network and a server.

2. Related Art

Generally, computer systems may be approximately categorized into reprogrammable systems and embedded systems. The reprogrammable system is similar to a common personal computer system having a hard disk device capable of storing a large volume of data disposed therein, and a user may edit and load different programs into the hard disk at any time, and may call the programs for use or modify the programs at any time. The embedded system is generally to record a compressed compiled program in a programmable nonvolatile memory. When the embedded system is booted, the embedded system automatically decompresses content stored in the programmable nonvolatile memory, and then loads the content into a random access memory (RAM) for execution, so as to enable the embedded system to enter a normal working state. However, since the user is not allowed to modify the program code recorded in the programmable nonvolatile memory, the user generally cannot edit the program code directly.

Therefore, the program code in the embedded system is generally referred to as firmware, which is widely applied in personal electronic devices such as mobile phones, personal digital assistants and network cameras. However, because of the rapid pace of technological development, incorrect programs may be designed in the original firmware, or the function may not be perfect. Therefore, it is common to continuously develop various new firmware versions in order to alleviate the problems, so the program code recorded in the programmable nonvolatile memory needs to be updated. However, problems often occur when the firmware is updated, for example, the original firmware version has an error, fails to operate, and thus cannot be updated to a new firmware version, or the firmware update fails due to emergency circumstances such as power failure in the firmware update process because of unstable system voltage or carelessness of the user. The most severe problem is that the system boot program code in the firmware is damaged, which leads to the consequence that the system cannot be booted normally, and has to be sent back to the manufacture for repair, resulting in inconvenience for the user and manufacture.

In order to effectively solve the above problems, a conventional means is to store two firmware copies in two regions of the nonvolatile memory in the embedded system. FIG. 1 is a schematic view of functional blocks in an embedded system 1 in the prior art. The first firmware copy is stored in a first region 101 of the nonvolatile memory 10, and is the primary firmware that needs to be loaded for normal operation. The second firmware copy is stored in a second region 102, and is the backup firmware for recovering the system when the firmware update fails and the primary firmware is damaged. The recovery method is as follows: a processor 11 reads the backup firmware originally stored in the second region, and writes the backup firmware to the first region to replace the damaged primary firmware. As such, the system can be rebooted successfully, and recovers to normal operation, and at this time, the user can select whether to update the firmware.

However, in the prior art, since the content of the backup firmware is basically the same as that of the primary firmware, the two firmware copies occupy almost the same memory space, so that the capacity of the nonvolatile memory needs to be increased accordingly, and as a result, the product cost of the embedded system is increased. Therefore, it is a major problem to be solved in the present invention to reduce the required memory space without impairing the system backup and recovery capabilities.

### SUMMARY OF THE INVENTION

The present invention discloses a system recovery method used between an embedded system and a server. The embedded system at least comprises a processor, a network connection module, and a nonvolatile memory. The nonvolatile memory stores a second part program code. The method comprises: loading the second part program code, in which the second part program code is used for enabling the network connection module; when the embedded system in a boot process determines that a first part program code in the nonvolatile memory does not satisfy a first specific condition, transmitting a signal through the network connection module to establish a signal connection with the server, in which the first part program code is a kernel in the boot process; and downloading a backup program code from the server through the network connection module for execution to complete the boot process.

According to an embodiment of the present invention, after “executing a first stage of a boot process”, the system recovery method further comprises: when the embedded system in the boot process determines that the second part program code in the nonvolatile memory does not satisfy a second specific condition, reading a second part backup program code from the nonvolatile memory to replace the second part program code; and reentering the boot process.

The present invention further discloses an embedded system with an automatic recovery function, for connection to a server. The embedded system comprises a nonvolatile memory, a network connection module and a processor. The nonvolatile memory stores a first part program code. The network connection module is for connection to the server. The processor is electrically connected to the nonvolatile memory and the network connection module. When the first part program code in the nonvolatile memory does not satisfy a first specific condition, the processor transmits a signal through the network connection module to establish a signal connection with the server, and downloads a backup program code from the server for execution to complete a boot process of the embedded system. The first part program code is a kernel in the boot process.

According to an embodiment of the present invention, the embedded system further comprises: a random access memory (RAM), electrically connected to the processor, for loading the backup program code to execute the boot process.

According to an embodiment of the present invention, when the processor determines that a second part program code in the nonvolatile memory does not satisfy a second specific condition, the processor reads a second part backup program code from the nonvolatile memory to replace the second part program code, and then reenters the boot process, in which the second part program code is used for enabling the nonvolatile memory, the RAM and the network connection module.

Based on the above, the system recovery method and the embedded system with the automatic recovery function of the present invention can greatly save the storage space of the nonvolatile memory without affecting the system backup and recovery capabilities.

### BRIEF DESCRIPTION OF THE DRAWINGS

The present invention will become more fully understood from the detailed description given herein below for illustration only, and thus are not limitative of the present invention, and wherein:

FIG. 1 is a schematic view of functional blocks in an embedded system in the prior art;

FIG. 2 is a schematic view of functional blocks in an embedded system applying a system recovery method of the present invention;

FIG. 3 is a schematic flow chart of a first embodiment of the system recovery method of the present invention;

FIG. 4 is a schematic flow chart of a second embodiment of the system recovery method of the present invention; and

FIG. 5 is a schematic flow chart of a third embodiment of the system recovery method of the present invention.

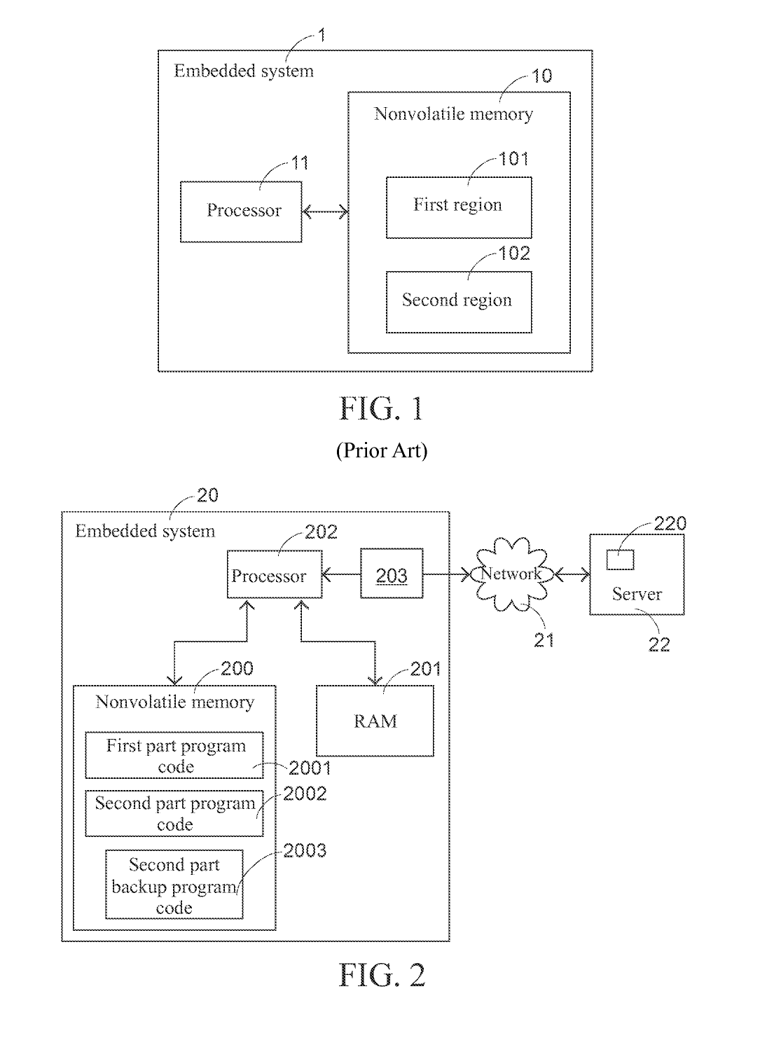

### DETAILED DESCRIPTION OF THE INVENTION

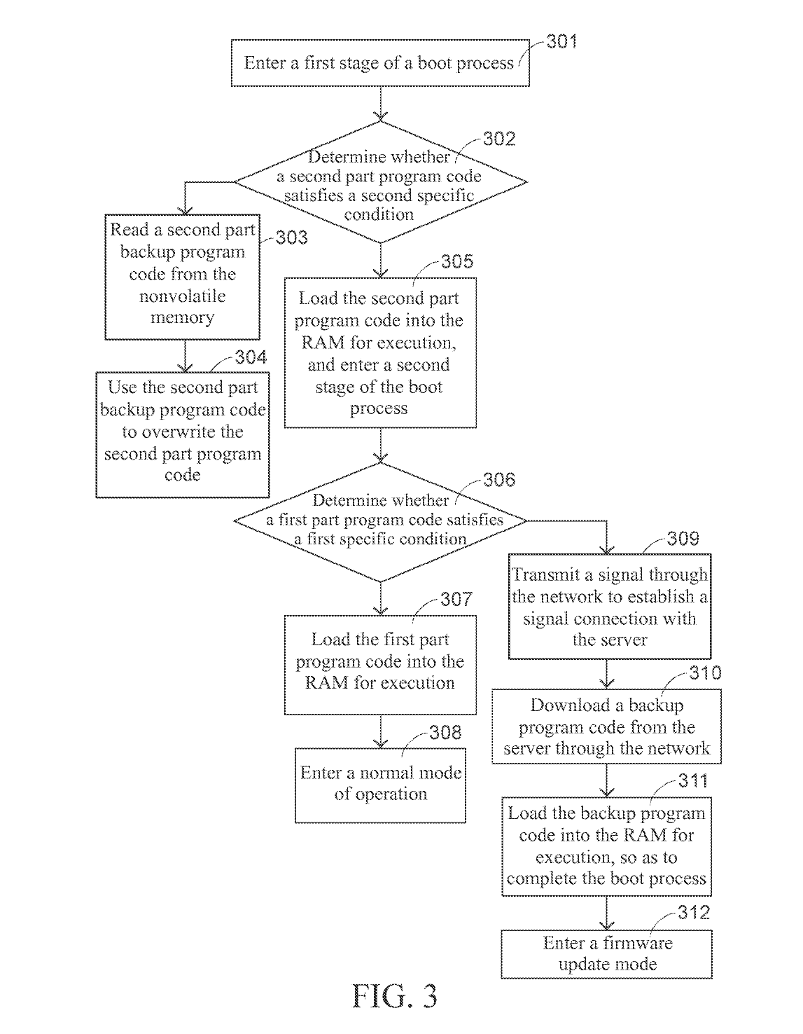

FIG. 2 is a schematic view of functional blocks in an embedded system applying a system recovery method of the present invention. Referring to FIG. 2, an embedded system 20 is used for establishing a signal connection with a server 22 through a network 21. The embedded system 20 comprises a nonvolatile memory 200, a random access memory (RAM) 201, a processor 202 and a network connection module 203. FIG. 3 is a schematic flow chart of a first embodiment of the system recovery method of the present invention. The embedded system 20 may be any embedded system with a network connection function, such as a common network camera or digital set top box. The processor 202 may be implemented as a microcontroller or a central processing unit (CPU). The nonvolatile memory 200 may be a flash memory or a read only memory (ROM). The RAM 201 may be a dynamic random access memory (DRAM). The network connection module 203 may be a wired or wireless network module.

Firstly, when started by a user, the embedded system 20 enters a first stage of a boot process (Step 301) to enable the processor 202. Then, the embedded system 20 determines whether a second part program code 2002 in the nonvolatile memory 200 satisfies a second specific condition (Step 302), in which the second part program code 2002 is used for enabling the nonvolatile memory 200, the RAM 201 and the network connection module 203 of the embedded system 20. If the determination result of Step 302 is no, indicating that the second part program code 2002 is damaged for some reasons, a second part backup program code 2003 is read from the nonvolatile memory 200 (Step 303), and is used to replace the second part program code 2002. Accordingly, the second part backup program code 2003 is written to the storage position of the second part program code 2002, so as to overwrite the second part program code 2002 (Step 304), and then the first stage of the boot process is reentered. If the determination result of Step 302 is yes, indicating that the second part program code 2002 is correct, the second part program code 2002 is loaded into the RAM 201 for execution, so as to enter a second stage of the boot process (Step 305).

After entering the second stage of the boot process, the embedded system 20 further determines whether a first part program code 2001 in the nonvolatile memory 200 satisfies a first specific condition (Step 306). The first part program code 2001 is a kernel in the boot process, and is used for loading an operating system, allocating memory resources, and checking peripheral devices. If the determination result of Step 306 is yes, indicating that the first part program code 2001 is correct, the embedded system 20 loads the first part program code 2001 into the RAM 201 for execution (Step 307), such that the embedded system 20 enters a normal mode of operation (Step 308). If the determination result of Step 306 is no, indicating that the first part program code 2001 is damaged for some reasons, the embedded system 20 enters a network backup and repair process. In the process, the embedded system 20 firstly transmits a signal through the network 21 to establish a signal connection with the server 22 (Step 309), downloads a backup program code 220 from the server 22 through the network 21 (Step 310), and loads the backup program code 220 into the RAM 201 for execution (Step 311), so as to complete the boot process and enter a firmware update mode (Step 312).

Definitely, the backup of the first part program code 2001 and the backup of the second part program code 2002 may both be stored in the backup program code 220, so as to further save the cost of the nonvolatile memory 200.

In addition, the second part program code 2002 or the second part backup program code 2003 executed in the first stage of the boot process is merely a portion of the boot program code. Taking an embedded Linux system for example, the second part program code 2002 or the second part backup program code 2003 belongs to armboot program code in the system, merely accounting for a small portion of the boot program code of the embedded Linux system, and occupying only a small storage space. Therefore, the defects of conventional means are eliminated effectively. The kernel and root file system of the Linux boot program code accounting for most of the data volume is allocated into the first part program code 2001, while in the present invention, the backup program code 220 having the large data volume is stored in the server 22 at the remote end of the network, without occupying any hardware resource of the embedded system.

Moreover, the steps of determining whether the first specific condition is satisfied and determining whether the second specific condition is satisfied may be accomplished by an error detection process performed by the processor, and the error detection process may be a parity bit check method or a block sum check method that is commonly used for digital data error detection.

In the network backup and repair process, the embedded system 20 may establish the signal connection with the server 22 at the remote end of the network through the Bootstrap Protocol, and thus, the embedded system 20 may download a recovery image of the backup program code from the server 22 at the remote end of the network through the Trivial File Transfer Protocol (TFTP), and load the recovery image into the RAM 201 for execution, so as to complete the boot process and enter the firmware update mode, such that the embedded system 20 that cannot be booted normally can update the firmware to the latest version. Definitely, other network protocols may also be used in addition to the Bootstrap Protocol and the TFTP.

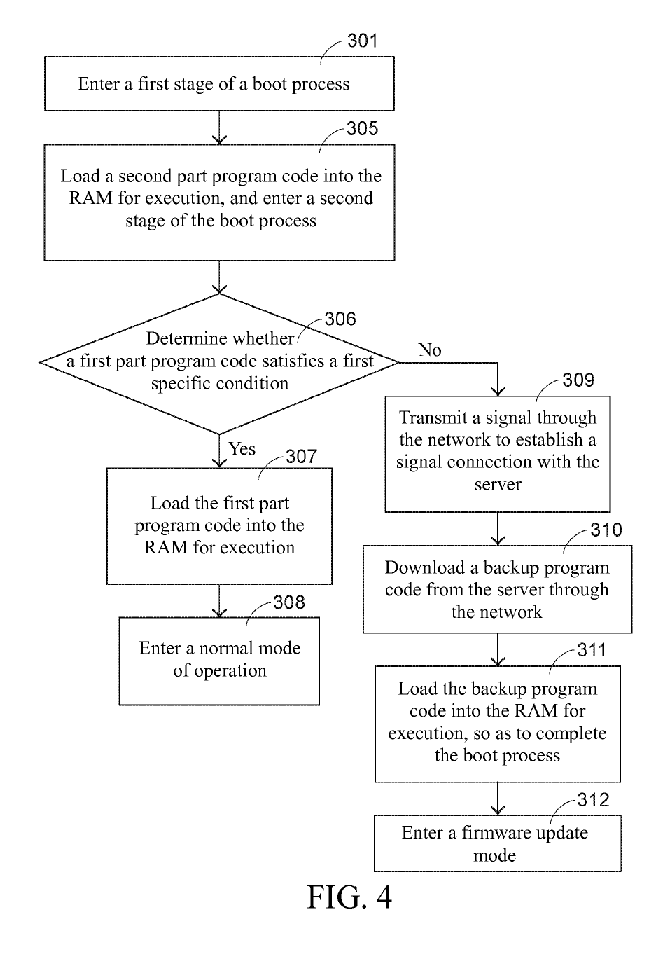

FIG. 4 is a schematic flow chart of a second embodiment of the system recovery method of the present invention. Since the second part program code 2002 or the second part backup program code 2003 is merely a basic portion of the boot program code (for example, the armboot program code in the embedded Linux system), some manufactures do not update this portion in the firmware update process, so the probability of an error in the second part program code 2002 caused by update is near zero. Therefore, in this embodiment, the storage of the second part backup program code 2003 can be omitted, and Steps 302, 303 and 304 in the first embodiment can be omitted, such that the second stage of the boot process (Step 305) and subsequent processes are entered directly.

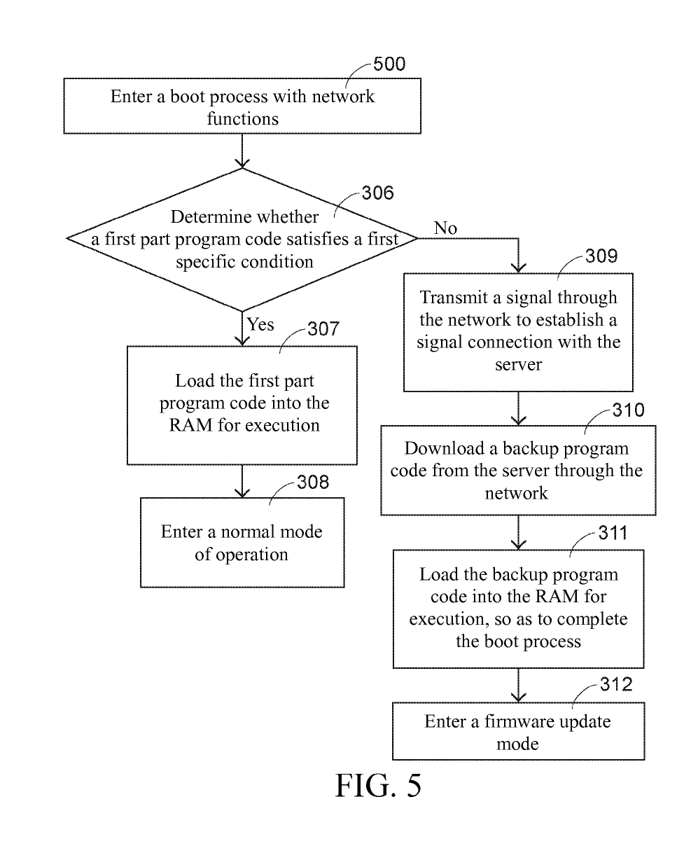

Moreover, when the embedded system 20 integrates the second part program code 2002 responsible for the second stage of the boot process and the program code responsible for the first stage of the boot process, the system can support network functions immediately after entering the boot process. FIG. 5 is a schematic flow chart of a third embodiment of the system recovery method of the present invention. As shown in FIG. 5, the system may directly enter the process of determining whether the first part program code 2001 in the nonvolatile memory 200 satisfies the first specific condition (Step 306) after completing a boot process with network functions (Step 500). Subsequent steps are the same as the above embodiments, so the details will not be described herein again.

As such, the present invention can effectively reduce the requirements for the nonvolatile memory and thus reduce the product cost of the embedded system without impairing the system backup and recovery capabilities, thereby solving the problem to be solved by the present invention. In addition, the method of the present invention can be widely applied in embedded systems with a network connection function, so various modifications made to the present invention by persons skilled in the art shall fall within the scope of the appended claims.

What is claimed is:

1. A system recovery method, used between an embedded system and a server, wherein the embedded system at least comprises a processor, a network connection module, and a nonvolatile memory, and the nonvolatile memory stores a second part program code, the method comprising:
executing a first stage of a boot process;
loading the second part program code;
when the embedded system in the boot process determines that a first part program code in the nonvolatile memory does not satisfy a first specific condition, transmitting a signal through a network to establish a signal connection with the server; and
downloading a backup program code from the server through the network connection module for execution to complete the boot process.

2. The system recovery method according to claim 1, wherein the first stage of the boot process is used for enabling the processor.

3. The system recovery method according to claim 2, wherein the second part program code is used for enabling the network connection module.

4. The system recovery method according to claim 3, wherein the first part program code is a kernel in the boot process.

5. The system recovery method according to claim 1, wherein after “executing a first stage of a boot process”, the method further comprises:
when the embedded system in the boot process determines that the second part program code in the nonvolatile memory does not satisfy a second specific condition, reading a second part backup program code from the nonvolatile memory to replace the second part program code; and
reentering the boot process.

6. The system recovery method according to claim 5, wherein an error detection process is used to determine whether the first part program code does not satisfy the first specific condition and whether the second part program code does not satisfy the second specific condition.

7. The system recovery method according to claim 6, wherein the error detection process is a parity bit check method or a block sum check method.

8. The system recovery method according to claim 1, further comprising: when the embedded system in the boot process determines that the first part program code in the nonvolatile memory satisfies the first specific condition, loading the first part program code for execution to complete the boot process and enter a normal mode.

9. The system recovery method according to claim 1, wherein the backup program code is loaded into a random access memory (RAM) in the embedded system for execution to complete the boot process and enter a firmware update mode.

10. An embedded system with an automatic recovery function, for connection to a server, the embedded system comprising:
a nonvolatile memory, for storing a first part program code;
a network connection module, for connecting to the server; and
a processor, electrically connected to the nonvolatile memory and the network connection module, wherein when the first part program code in the nonvolatile memory does not satisfy a first specific condition, the processor transmits a signal through the network connection module to establish a signal connection with the server, and downloads a backup program code from the server for execution to complete a boot process of the embedded system.

11. The embedded system with the automatic recovery function according to claim 10, wherein the first part program code is a kernel in the boot process.

12. The embedded system with the automatic recovery function according to claim 10, further comprising: a random access memory (RAM) electrically connected to the processor, for loading the backup program code to execute the boot process.

13. The embedded system with the automatic recovery function according to claim 10, wherein when the processor determines that a second part program code in the nonvolatile memory does not satisfy a second specific condition, the processor reads a second part backup program code from the nonvolatile memory to replace the second part program code, and then reenters the boot process.

14. The embedded system with the automatic recovery function according to claim 13, wherein an error detection process is used to determine whether the first part program code does not satisfy the first specific condition and whether the second part program code does not satisfy the second specific condition.

15. The embedded system with the automatic recovery function according to claim 14, wherein the error detection process performed by the processor is a parity bit check method or a block sum check method.

16. The embedded system with the automatic recovery function according to claim 10, wherein when the processor determines that the first part program code in the nonvolatile memory satisfies the first specific condition, the processor loads the first part program code for execution to complete the boot process and enter a normal mode.
